(19) United States
(12) Patent Application Publication
(10) Pub. No.: US 2017/0246567 A1
(43) Pub. Date: Aug. 31, 2017

(54) Filtering Pump System

(71) Applicant: Attitude Systems, LLC, Huntington Beach, CA (US)

(72) Inventors: Donald E. Mabe, JR., Huntington Beach, CA (US); Brent Hepner, St. Augustine, FL (US)

(73) Assignee: Attitude Systems, LLC, Huntington Beach, CA (US)

(21) Appl. No.: 15/437,519

(22) Filed: Feb. 21, 2017

Related U.S. Application Data
(60) Provisional application No. 62/301,051, filed on Feb. 29, 2016.

(51) Int. Cl. B01D 35/26; B01D 29/58; B01D 29/92; B01D 35/02; F04D 29/70; B01D 17/02; B01D 15/36; F04D 13/06; F04D 13/04; F04D 15/02; B01D 29/33; B01D 24/10

(52) U.S. Cl. CPC B01D 35/26; B01D 29/33; B01D 29/58; B01D 29/925; B01D 35/02; B01D 24/10; B01D 17/0202; B01D 15/361; F04D 13/06; F04D 13/04; F04D 15/0218; F04D 29/708; B01D 2201/64

(57) ABSTRACT

In certain embodiments, a system filter has a hollow, perforated, inner structure inside a hollow, perforated, outer structure that define an annular gap that receives granular filtering media retained by an (optional) media liner. An outer filter surrounds the outer structure. An (electric) pump may be located within the inner cavity of the inner structure or external to the system filter. When deployed in an underground vault, vault water flows through the outer filter, the outer structure, the outer portion of the media liner (if present), the filtering media, the inner portion of the media liner (if present), and the inner structure into the inner cavity from where the pump moves the filtered water out of the vault. The outer filter and/or the media liner may have a lipophobic, hydrophilic material that allows water to pass while blocking lipids without having the lipids adhere to the material.

### CROSS-REFERENCE TO RELATED APPLICATIONS

This application claims the benefit of the filing date of U.S. provisional application No. 62/301,051, filed on Feb. 29, 2016 as attorney docket no. ATTS-1001USP, the teachings of which are incorporated herein by reference in their entirety.

### BACKGROUND

Field of the Invention

The present invention relates to systems for filtering and pumping liquids and, more particularly but not exclusively, to dewatering systems for filtering and pumping water from underground vaults, manholes, handholds, substation structures, and the like.

Description of the Related Art

This section introduces aspects that may help facilitate a better understanding of the invention. Accordingly, the statements of this section are to be read in this light and are not to be understood as admissions about what is prior art or what is not prior art.

The manual and automatic dewatering of chronic water infiltration into underground vaults is being forced to evolve with ever-increasing environmental regulations in stormwater management. In the past, the settled vault water was simply pumped onto the street to flow into the closest storm drain. In an automated system using conventional sump pumps, there was no way of knowing what was being pumped, if it wasn't being observed. A pump could pump into a storm drain pure hydraulic or dielectric fluids as well as sediments and illicit discharges from episodic events, and even dissolved metals. Because of this fact, either secondary containment or a method for stopping free oil resulting from a leak or spill event, contaminated sediments, and even dissolved pollutants was required. Others have attempted to adsorb/absorb or solidify the oils or remove pollutants by wrapping fabrics impregnated with adsorbents/absorbents or solidifiers around the outside of the pump housing with little effect on secondary containment or pollutant removal due to the small amount of adsorbents/absorbents or solidifiers used. In this method, to get enough adsorbents/absorbents or solidifiers to provide secondary containment or pollutant removal, would require multiple wrappings of the fabric, thereby reducing the flow rate of unpolluted water to an unacceptable level. Additionally, the cost and time imposed by vacuuming the fluids, hauling them off for treatment poses risk, cost, and time-management issues, not to mention the cost of depredating equipment, especially high-voltage electrically energized equipment, by allowing too much water to remain in the vault too frequently.

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a perspective view of a filtering pump system according to certain embodiments of the present invention;

FIG. 2 is an exploded, perspective view of some of the components of the system of FIG. 1,

FIG. 3 is a cross-sectional side view of the system of FIG. 1 according to certain embodiments that employ a media liner;

FIG. 3A is an enlarged view of a portion of the cross-sectional side view of FIG. 3;

FIG. 4 is a perspective view of the perforated outer cylinder of the system of FIG. 1;

FIG. 5 is a perspective view of the perforated inner cylinder of the system of FIG. 1;

FIG. 6 is a plan view of the inner surface of the base of the system of FIG. 1;

FIG. 7 is a plan view of the inner surface of the lid of the system of FIG. 1; and

FIG. 8 is a perspective view of the electric pump mounted onto the base of the system of FIG. 1.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative embodiments, the functions/acts noted may occur out of the order noted in the figures. For example, two figures shown in succession may in fact be executed substantially concurrently or may sometimes be executed in the reverse order, depending upon the functionality/acts involved.

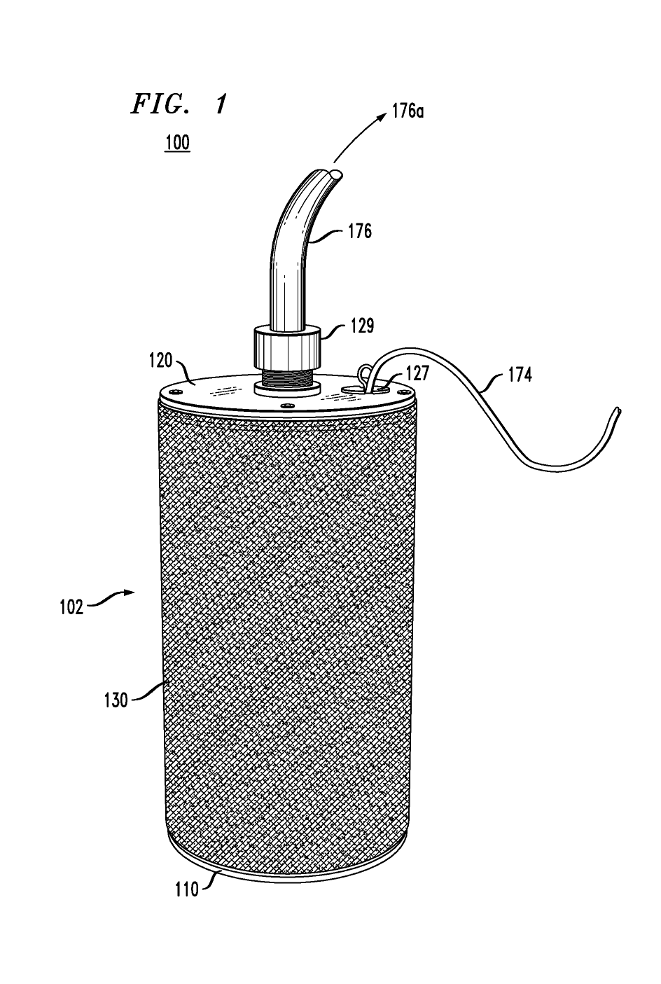

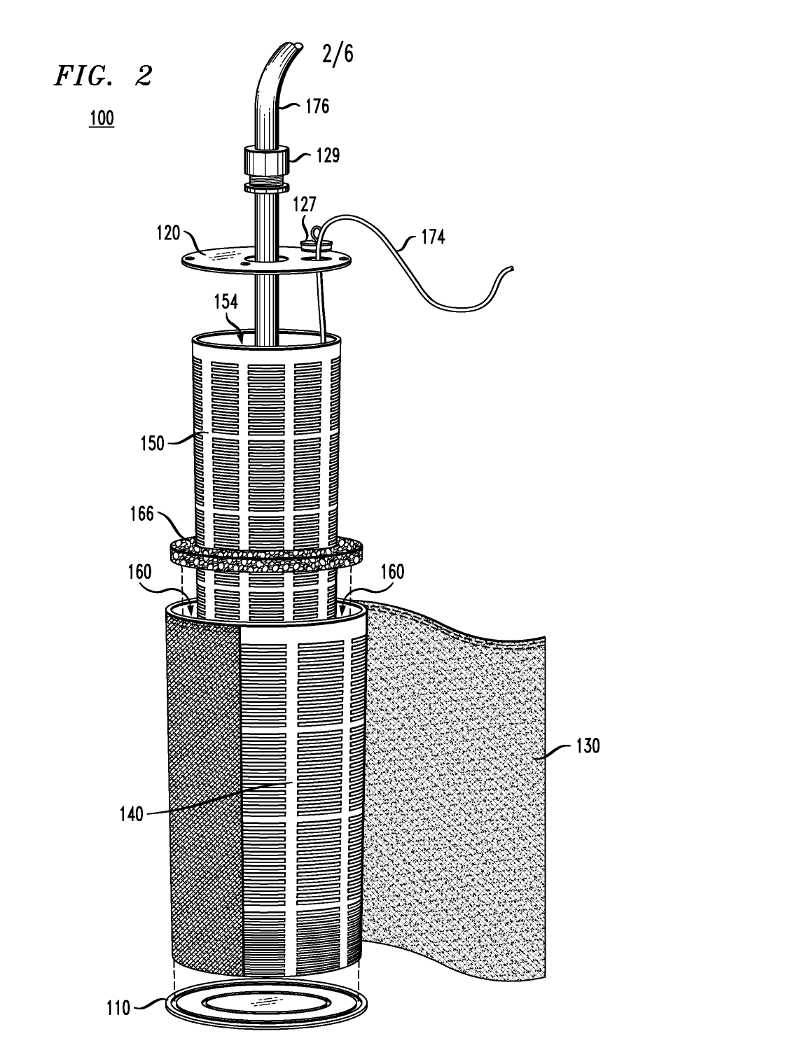

FIGS. 1-8 show various views of a filtering pump system 100 and some of its components according to certain embodiments of the present invention. The filtering pump system 100 is designed to be deployed to dewater an underground vault or other suitable location while preventing undesirable contaminants from being pumped out of the structure.

As shown in FIGS. 1-8, the filtering pump system 100 has a substantially cylindrical system filter 102 located between an impervious, circular base 110 and an impervious, circular lid 120. The system filter 102 comprises an outer filter 130 that is wrapped around a perforated, hollow, outer cylinder 140. The composition of the outer filter 130 will be further described below. Located within the cavity of the outer cylinder 140 is a perforated, hollow, inner cylinder 150, whose outer diameter is less than the inner diameter of the outer cylinder 140 such that there is an annular gap 160 between the inner surface of the outer cylinder 140 and the outer surface of the inner cylinder 150. As used in this specification, the term “inner” refers to a direction towards the center of the filtering pump station 100 or a relative location closer to the center of the filtering pump system 100, and the term “outer” refers to a direction away from or a relative location further from the center of the system 100.

As shown in FIGS. 1-8, the filtering pump system 100 has an overall cylindrical shape with outer and inner cylinders 140 and 150 configured with a circular base 110 and a circular lid 120. In alternative embodiments, filtering pump systems of the present invention and their respective components may have other suitable shapes. For example, in some embodiments, the filtering pump systems have an overall rectilinear shape with rectilinear outer and inner structures, instead of the outer and inner cylinders 140 and 150, configured with a rectangular base and a rectangular lid, instead of the circular base 110 and lid 120.

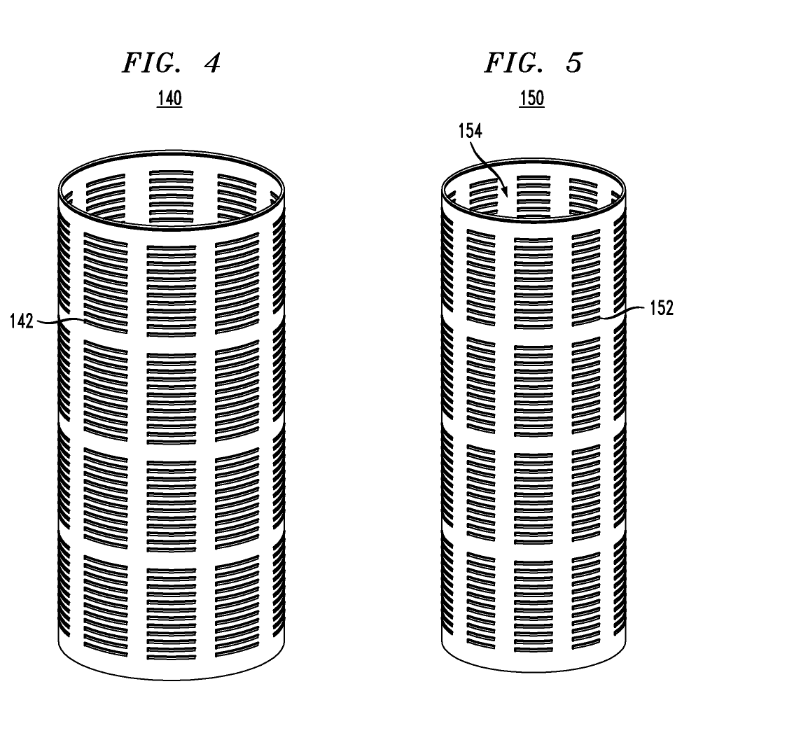

As shown in FIGS. 4 and 5, the outer and inner cylinders 140 and 150 each have horizontal slots 142 and 152 that form perforations through the cylinder walls. In other embodiments, the perforations may have suitable shapes and/or orientations other than horizontal slots, such as vertical slots or circular holes. The number, sizes, and shapes of the perforations contribute to the Apparent Open Area (AOA) of each cylinder and may vary according to the application. In certain embodiments, the cylinders 140 and 150 are made of stainless steel. In alternative embodiments, the cylinders 140 and 150 may be made of other suitable materials, such as a suitable polymer plastic like polyester (PES), polyethylene terephthalate (PET), polyethylene (PE), high-density polyethylene (HDPE), polyvinyl chloride (PVC), polyvinylidene chloride (PVDC), low-density polyethylene (LDPE), polypropylene (PP), polystyrene (PS), high-impact polystyrene (HIPS), polyamides (PA) (i.e., nylons), acrylonitrile butadiene styrene (ABS), polyethylene/acrylonitrile butadiene styrene (PE/ABS), polycarbonate (PC), polycarbonate/acrylonitrile butadiene styrene (PC/ABS), polyurethanes (PU), or other suitable organic or inorganic materials.

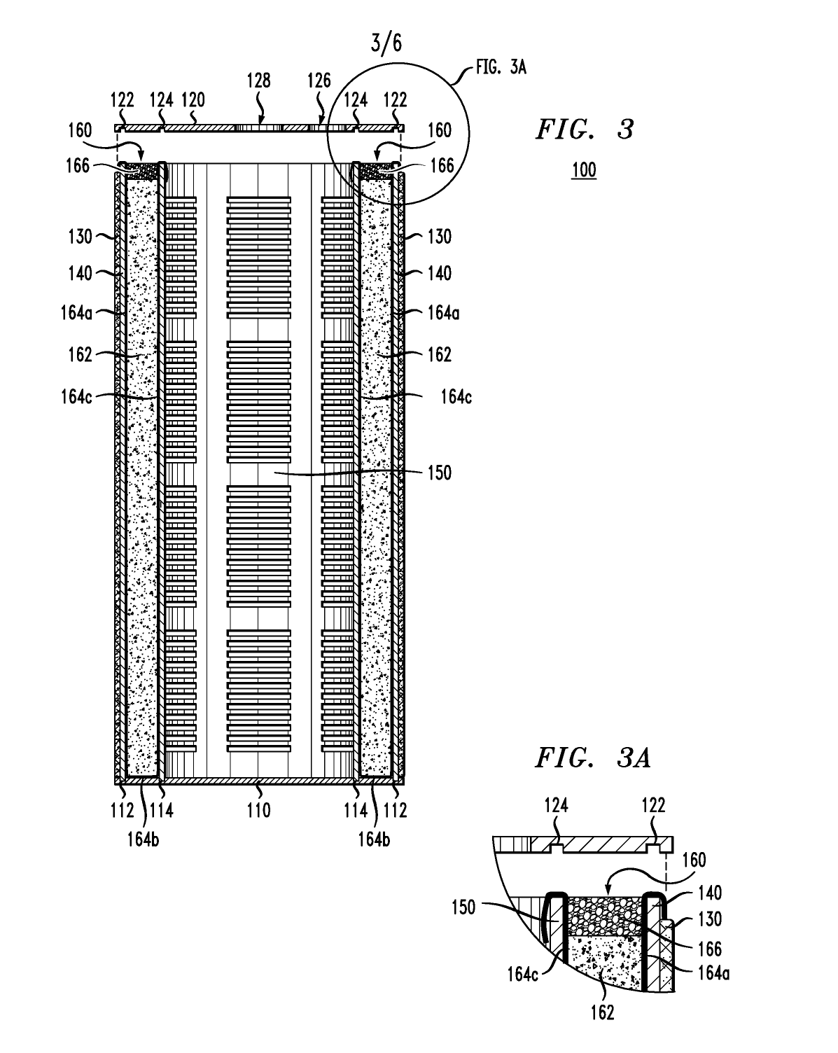

Located within the annular gap 160 between the cylinders 140 and 150 is granular filtering media 162. In some embodiments of the filtering pump system 100, a media liner 164 is employed to retain the granular filtering media 162 within the annular gap 160. As shown in FIG. 3, such a media liner 164 has an outer portion 164a that runs along the inner surface of the outer cylinder 140, a bottom portion 164b that runs along the portion of the inner surface of the base 110 corresponding to the annular gap 160, and an inner portion 164c that runs along the outer surface of the inner cylinder 150 to form a cylindrical, annular container that receives the granular filtering media 162 and prevents the filtering media 162 from exiting the annular gap 160 through the slots 142/152 in the outer and inner cylinders 140 and 150. In some other embodiments of the system 100, the granular filtering media 162 has sufficiently large grains relative to the size of the cylinder slots 142/152, such that the filtering media 162 cannot fit through the slots, and the media liner 164 can be omitted from the system. The compositions of the filtering media 162 and the media liner 164 are described in further detail below.

An electric pump 170 is located within the inner cavity 154 of the hollow inner cylinder 150 and mounted to the inner surface of the base 110 via a cylindrical, pump bracket 172. Note that the inner cavity 154 of the inner cylinder 150 is also the inner cavity 154 of the filtering pump system 100. As shown in FIG. 8, the pump bracket 172 is mounted to the inner surface of the base 110 via mounting threads 116 that are rigidly connected to the base 110, and the electric pump 170 snaps into the cylindrical recess of the pump bracket 172 by way of spring action using a retention groove (not shown) in the pump bracket.

The pump bracket 172 is made of a suitable material, such as stainless steel. The electric pump 170 has an electrical cable 174 that provides power to the electric pump 170, a discharge hose 176 through which liquids are pumped away from the electric pump 170, and a float assembly 178 that automatically turns on and off the electric pump 170 based on the level of liquid within the inner cavity 154 of the inner cylinder 150. The pump electrical cable 174 and the pump discharge hose 176 both extend through corresponding openings 126 and 128 in the lid 120. The pump electrical cable 174 is secured within the cable opening 126 by a cord seal 127, while the pump discharge hose 176 is secured within the hose opening 128 by a quick-connect hose gland 129.

In the embodiment shown in the figures, the electric pump 170 has a controller (not shown) that implements zero-switching technology, such that the controller turns on the electric pump 170 when the float assembly 178 rises above a specified turn-on set point and the controller turns off the electric pump 170 when the float assembly 178 falls below a specified turn-off set point. In a typical configuration, the set points are fixed with the turn-on set point at a higher liquid level than the turn-off set point. Zero-switching technology is described, for example, in U.S. Pat. No. 5,402,329, the teachings of which are incorporated herein by reference in their entirety.

In alternative embodiments, the electric pump 170 may have a number of stationary level sensors, such as capacitance sensors and magnetic-field (e.g., Hall-effect) sensors from TouchSensor Technologies LLC of Wheaton, Ill., configured at different elevations along the height of the electric pump 170 to detect a range of liquid levels within the inner cavity 154. In some of these embodiments, a PID (proportional-integral-derivative) controller uses inputs from the multiple level sensors to handle situations such as plugging. Plugging occurs when sediments or oil slowly reduce the inflow of water to the pump cavity before complete shutoff is obtained. A PID controller can be configured to monitor the rates of change in liquid level during times when the electric pump 170 is on and during times when the electric pump 170 is off in order to detect the occurrence of plugging. In response, the controller can adaptively modify the operations of the electric pump 170, for example, to make the electric pump 170 run longer by adjusting the turn-on and turn-off set points and/or adjusting the speed of the electric pump 170 to maintain an acceptable level of liquid in the underground vault. In particular, when plugging is detected, the controller may adjust the turn-off set point to be at a lower level and may cause the electric pump 170 to run at a slower speed to accommodate the slower inflow of liquid.

Other types of liquid-level sensors that may be used in different embodiments include flow sensors, moisture sensors, barometric pressure sensors, and touch sensors. Liquid-level sensors are described, for example, in U.S. Pat. Nos. 5,594,222, 6,310,611, 6,320,282, and 7,373,817, the teachings of all of which are incorporated herein by reference in their entirety.

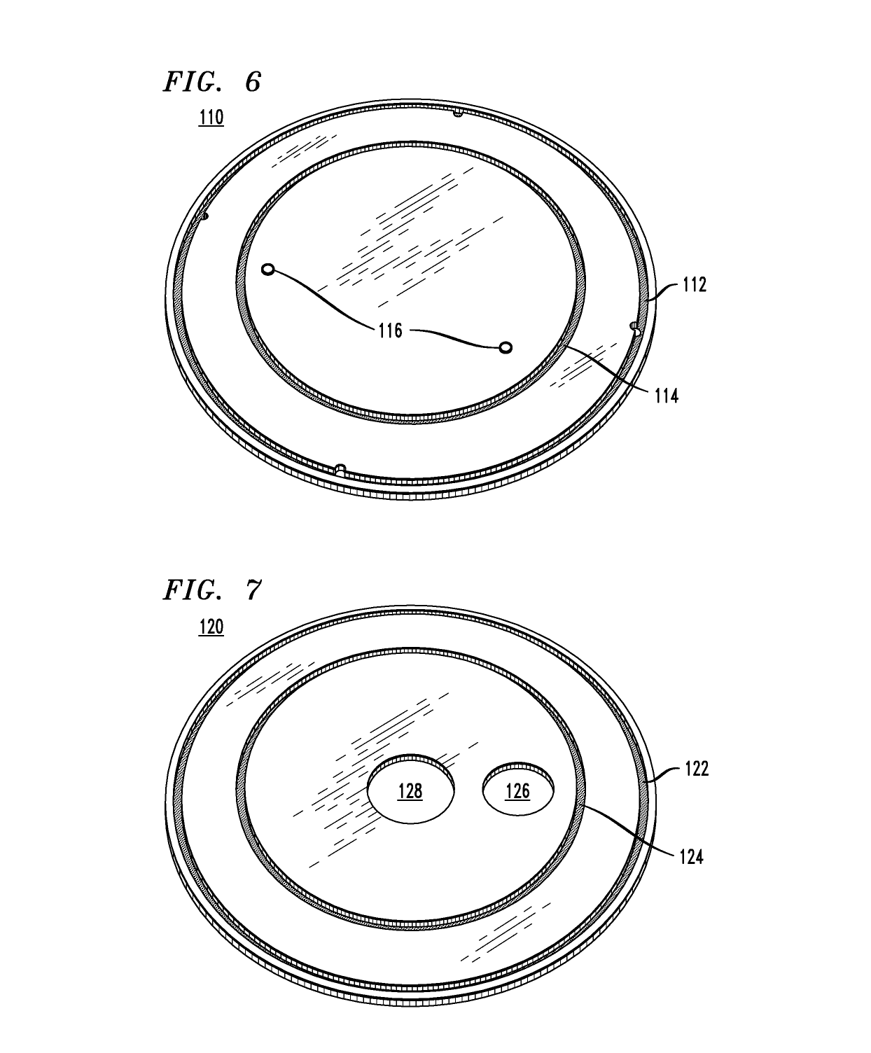

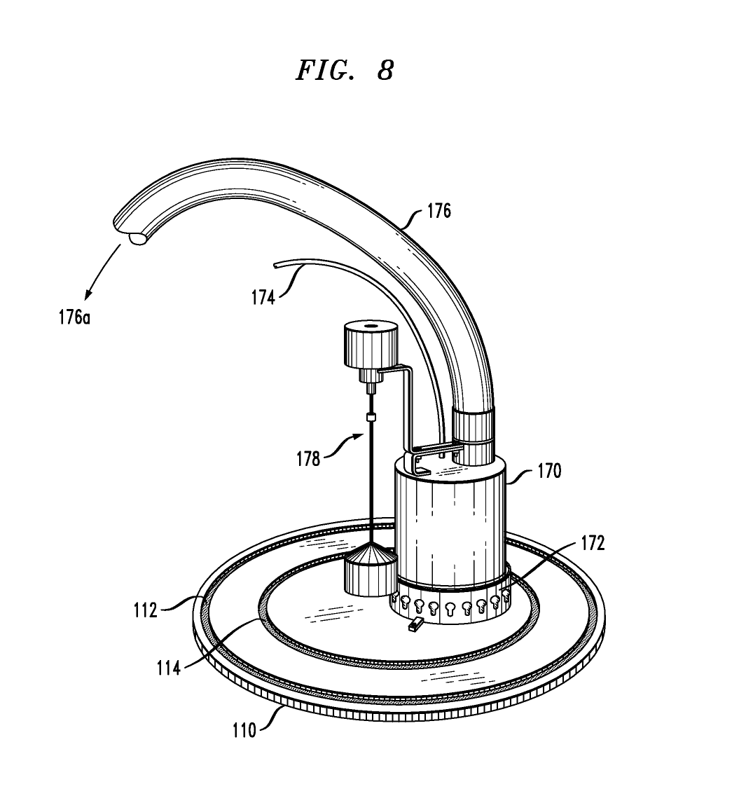

As shown in FIG. 6, the inner surface of the base 110 has a circular outer retention groove 112 for receiving the bottom of the outer cylinder 140 and a smaller-diameter, circular inner retention groove 114 for receiving the bottom of the smaller-diameter, inner cylinder 150. Similarly, as shown in FIG. 7, the inner surface of the lid 120 has a circular outer retention groove 122 for receiving the top of the outer cylinder 140 and a smaller-diameter, circular inner retention groove 124 for receiving the top of the smaller-diameter, inner cylinder 150. In certain embodiments, the base 110 and lid 120 are made of a suitable plastic material such as polyester (PES), polyethylene terephthalate (PET), polyethylene (PE), high-density polyethylene (HDPE), polyvinyl chloride (PVC), polyvinylidene chloride (PVDC), low-density polyethylene (LDPE), polypropylene (PP), polystyrene (PS), high-impact polystyrene (HIPS), polyamides (PA) (e.g., nylons), acrylonitrile butadiene styrene (ABS), polyethylene/acrylonitrile butadiene styrene (PE/ABS), polycarbonate (PC), polycarbonate/acrylonitrile butadiene styrene (PC/ABS), or polyurethanes (PU). In other embodiments, the base and lid may be made of other suitable materials, such as stainless steel.

The outer cylinder 140 is mounted onto the base 110 using suitable, tapped mounting brackets and screws. Similarly, the lid 120 is mounted onto the outer cylinder 140 using suitable, tapped mounting brackets and screws. The inner cylinder 150 is held in place by the inner retention grooves 114 and 124 of the base 110 and lid 120, respectively, while the securing of the base 110 and lid 120 to the outer cylinder 140 using brackets and screws holds the entire unit together, while providing easy disassembly.

As shown in FIG. 3, in some embodiments, a resilient media gasket 166 is placed within the annular gap 160 on top of the filtering media 162. The media gasket 166 is made of a resilient material, such as a compressible foam made of silicone, polyethylene, neoprene, polynitrile, or polyurethane, and is sized such that, when in an uncompressed state, the top of the media gasket 166 extends above the top rims of the outer and inner cylinders 140 and 150. When the lid 120 is mounted onto the system filter 102, the resilient media gasket 166 is compressed and applies suitable corresponding compression forces to the granular filtering media 162. The gasket 166 may be used to compress the filtering media 162 to prevent the granular media from moving or shifting to prevent channeling within the annular gap 160. Note that, in other embodiments of the filtering pump system 100, a similar resilient media gasket may be placed at the bottom of the annular gap 160 in addition to or instead of the media gasket 166 at the top of the annular gap 160. In general, one or more resilient media gaskets may be placed within the annular gap 160 at any suitable locations along the height of the annular gap 160.

One application for the filtering pump system 100 of FIGS. 1-8 is in underground vaults having conduits that convey electrical cabling and the like. In order to prevent water from accumulating in such a vault and potentially damaging the electrical cabling, the filtering pump system 100 may be deployed on the floor of the vault with the pump electrical cable 174 connected to a suitable source of electricity, and the pump discharge hose 176 configured with its distal end BG extending outside of the vault, for example, through the roof of the vault, to a suitable location, for example, into a storm drain or ground infiltration.

Under normal operating conditions, when a sufficient amount of (uncontaminated or only slightly contaminated) water accumulates on the floor of the vault, water will pass through the outer filter 130, through the slots 142 in the perforated, outer cylinder 140, through the outer portion 164a of the media liner 164 (if present), through the filtering media 162, through the inner portion 164c of the media liner 164 (if present), through the slots 152 in the perforated, inner cylinder 150, and into the inner cavity 154 of the pump system 100, which stages the filtered water in a lower pressure area prior to being discharged. If and when the water level eventually rises to a sufficient height, the float assembly 178 will turn on the electric pump 170, which will then pump the water out of the inner cavity 154 and thereby out of the vault through the pump discharge hose 176.

As the water within the inner cavity 154 is pumped out of the vault, more water, if present within the vault, will continue to free flow through the system filter 102 towards the electric pump 170. When the water level within the inner cavity 154 is eventually brought below a threshold level, the float assembly 178 will turn off the electric pump 170. In this way, the filtering pump system 100 keeps the water level within the vault at an acceptable level that will not result in damage to the electrical cabling within the vault.

If only pure water ever accumulated within underground vaults, then the filtering pump system 100 would not be needed. All that would be required would be a suitable electric pump similar to the electric pump 170. However, in order to prevent contaminants and other undesirable materials that may accumulate in an underground vault, either in addition to water or instead of water, from being pumped out of the vault and onto, for example, the street above the underground vault, the filtering pump system 100 is provided with the outer filter 130 and the filtering media 162 and, if needed, the media liner 164.

The outer filter 130 is designed to block gross pollutants, such as coarse and even fine sediments, leaves, twigs, cigarette butts and other trash, and/or certain hydrocarbons from passing into the pump system 100, while allowing water and certain other liquids to pass through. In one embodiment, the outer filter 130 comprises layers of overlapping textiles and/or screening, attached together and large enough to wrap around the circumference of the outer cylinder 140 and be secured with Velcro, hook and latch, banding, or other suitable mechanism. The textiles and/or screening can be of various materials including lofting materials constructed to provide specific functions such as micron exclusion, sheen removal, enhanced flows, and loading capacity. Materials may include natural fibers such as cotton, mineral fibers such as fiberglass, synthetic fibers such as nylon, polyester, polypropylene, rayon, spandex, acrylic, Kevlar®, or Nomex®. In other embodiments, the outer filter 130 may be made of any other suitable materials.

The granular filtering media 162 is designed to prevent certain types of contaminants from passing into the inner cavity 154 of the pump system 100. The types of contaminants to be blocked may be different for different deployments of the pump system 100 and therefore the composition of the filtering media 162 may also vary from deployment to deployment. Depending on the types of contaminants to be filtered and the composition of the filtering media 162, the filtering media 162 may perform one or more of sequestering, changing, exchanging, and encapsulating tasks to (i) remove one or more contaminants from the liquid reaching the filtering media 162 and/or (ii) modify the liquid itself. In certain embodiments, the filtering media 162 can encapsulate hydrocarbons, thereby preventing hydrocarbons from entering the inner cavity 154 and being discharged by the electric pump 170. In certain embodiments, these encapsulated hydrocarbons can swell within the annular gap 160, thereby eventually blocking further liquid from entering the inner cavity 154 and being pumped away from the pump system 100. Such an embodiment may function as a self-contained secondary containment device for spill prevention, control, and countermeasure (SPCC) applications.

Depending on the particular contaminants to be filtered, the filtering media 162 may include a combination of activated carbon, hydrocarbon solidifiers, metals removal media, and/or finer particulate removal media. The filtering media 162 may include oil solidifiers, oil adsorbents, oil absorbents, and metal sequestering agents such as, but not limited to, ion exchange resins or chelation agents. The filtering media 162 may include water modifiers for pH or bacterial control. In certain embodiments, the filtering media 162 can modify the pH of the liquid to comply with regulatory demands or to enhance the recovery or chelation of pollutants like metals. In certain embodiments, the filtering media 162 can sequester various dissolved metals, un-dissolved metals, nutrients, targeted organic pollutants, and/or targeted inorganic pollutants. In certain embodiments, the filtering media 162 can be modular to allow the user to change the media when the media is spent or change the media for a different targeted pollutant using the same apparatus.

The filtering media 162 may include solidifiers to provide a secondary-containment buffer. The solidifier will absorb oil molecules into its polymer structure and cross link the molecules into place so that they cannot leach out. Once the solidifier is completely saturated with oil, which may occur during an episodic oil release, the polymer will form into a rubbery viscous mass with the oil which will stop most or even all flow of water or oil, acting as a chemical shut-off valve preventing an environmental oil release. Suitable solidifiers that may be included in the filtering media 162 include norbornene (with or without solvents), styrene-ethylene butylene-styrene block copolymers, and styrene-butadiene block copolymers. The solidifiers are preferably food grade and nontoxic to aquatic species.

Specialized media such as ion-exchange resins and chelation agents can be used to remove heavy metals and nutrients. In addition or instead, natural biopolymers such as peat moss, crab shells as chiton, and dried vegetation have certain sequestering properties effective with dissolved metal removal. Inorganics such as zeolites, perlites, and activated carbons all have abilities for dissolved analyte removal that may be used.

Functionalized substrates using immobilized chelation ligands are quite specific for the heavy metals and can sequester specific metals in waters with highly dissolved solids such as brines and sea water and ground waters without saturation problems found in ion-exchange chemistries. The chelation chemistry also allows for recharging a spent system by acid stripping of the metals from the functionalized surface substrate. A Solid Phase Extraction chelation system can be used in certain embodiments of the present invention for heavy metal sequestration.

Crystal Clear Technologies of Franklin, Tenn., produces solid phase extractive media, which can be used to remove metals. The solid phase extraction (SPE) materials have demonstrated the ability to meet low ppb and ppt levels of ionized metal removal in complex wastewater streams. The nano-coatings (ligands) allow a robust technology road map that allows the SPE materials to be refined or modified to capture and remove contaminants on an ongoing basis.

U.S. Patent Publication No. US20130012379 A1, the teachings of which are incorporated herein by reference in its entirety, describes a material sold as Osorb® media by ABS Materials, Inc., of Wooster, Ohio, which provides removal of metals and selective dissolved polar organics such as antifreeze, and can be used singly or in combination with other described materials.

In one embodiment, the filtering media 162 comprises:
60% WT carbon, such as 007-55 Activated Carbon Coconut Shell 8×30 Mesh from Carbon Activated Corporation of Compton, Calif., which removes solvents, BTEX chemicals (i.e., benzene, toluene, ethylbenzene, and xylene), water-soluble organics, oils and greases, TPH (total petroleum hydrocarbon), and dissolved metals;
15% WT polymer, such as A610 Petro Bond Polymer from Nochar Inc. of Indianapolis, Ind., which provides secondary containment of hydrocarbons and absorption of TPH, VOCs (volatile organic compounds), oil, and grease;
10% WT calcite, such as Calcite FINE from Oldcastle Industrial Materials of Thomasville, Pa., which modifies water pH for compliance discharge and enhancement of analyte removal efficiency; and
15% WT functionalized chitosan, such as ChitoVan CF from Dungeness Environmental Solutions, Inc., of Everett, Wash., which provides chelation of water-soluble metal ions and acts as a flocculent to enhance filtration efficiency.

In another embodiment, the filtering media 162 comprises:
80% WT carbon, such as 007-55 Activated Carbon Coconut Shell 8×30 Mesh from Carbon Activated Corporation of Compton, Calif., which removes solvents, BTEX chemicals (i.e., benzene, toluene, ethylbenzene, and xylene), water-soluble organics, oils and greases, TPH (total petroleum hydrocarbon), and dissolved metals; and
20% WT polymer, such as A610 Petro Bond Polymer from Nochar Inc. of Indianapolis, Ind., which provides secondary containment of hydrocarbons and absorption of TPH, VOCs (volatile organic compounds), oil, and grease.

As described previously, when the grain size of the granular filtering media 162 is small enough that the grains can pass through the slots 142/152 in the perforated outer and inner cylinders 140 and 150, a suitable media liner 164 is used to keep the filtering media 162 in place within the annular gap 160 between the cylinders. Such a media liner 164 must be porous enough to allow water to pass through, but not porous enough to allow the filtering media grains to pass through.

Note that, depending on the compositions of the outer filter 130 and the media liner 164, the media liner may prevent some additional particulate matter from passing that it able to pass through the outer filter 130, thereby improving the overall filtering function of the pump system 100. When used to retain a loose filtering media 162 within the annular gap 160, the media liner 164 can be made of a porous material having an apparent opening size (AOS) that is dependent on the size of the filtering media particles. For example, for media particles greater than 25 to 100 microns in diameter, the media liner 164 can be made of a suitable textile or screen having openings smaller than that diameter.

In certain embodiments of the filtering pump system 100 that have a media liner 164, the media liner can perform certain filtering functions in addition to functioning to retain the filtering media 162 within the annular gap 160. Textiles used for the outer filter 130 and/or the media liner 164 can be selected to exclude suspended sediments from entering the annular gap 160 and being part of the effluent discharge. When Total Suspended Sediment compliance testing is performed with 1.5-micron filtration, the textiles used should be under the 1.5-micron rating, preferably 1 micron. In certain embodiments, the textiles can be any textile with any apparent opening size (AOS) of 1.5 micron or any suitable AOS if the textile has the ability to exclude 1.5-micron particles using filter cake buildup from the filtration or the filtering media 162 producing a 1.5-micron overall barrier. The textile composition may be polyethylene or polypropylene, but can be any other suitable fiber such as (without limitation) nylon, aramid, cotton, glass, metal, filtration screens, windings, spunbonds, filtration sponges, and foams. Combinations of textiles and fine screens, or combinations of layers using various micron-size ratings providing lofted combinations of high openings sizes to the defining 1.5 micron, may be used.

In certain embodiments, the media liner 164 comprises a textile composition made of polyethylene or polypropylene, but can be any other suitable fiber such as (without limitation) nylon, aramid, cotton, glass, metal, filtration screens, windings, or spunbonds. In certain embodiments, the media liner 164 is made of a material that allows oil to pass though the material, but wicks very little if any oil thereby inhibiting oil in the liquid from wicking around and bypassing the filtering media 162.

Conventional sorbent filtration fabrics are lipophilic and hydrophobic. As such, they allowed water to pass through the fabrics' interstitial spaces, while adsorbing the oil on the fabrics' fiber matrix. This conventional technique removes oil from water until the fiber media becomes saturated, when breakthrough will occur. The treatment process according to certain embodiments of the present invention literally makes a mirror image of the conventional sorbent filtration fabric. Instead of a lipophilic, hydrophobic fabric surface, the embodiments employ lipophobic, hydrophilic fabric surfaces where the water is adsorbed and oil is repelled. In both cases, water will eventually pass freely through, although, when the treated fabric is hydrophilic, water readily wets the fabric.

Fabric treated according to certain embodiments of the present invention beads up diesel fuel and Light Arabian crude oil, while conventional untreated, lipophilic fabric is wetted by such oils, which are sorbed into the lipophilic fabric. Certain embodiments of the present invention use this surface technology to enhance the properties of oil and sediment dewatering systems.

In certain embodiments, at least some of the materials (such as porous textiles or other fabrics) used in the outer filter 130 and/or the media liner 164 (if present) have hydrophilic and lipophobic characteristics, where the term “hydrophilic” means that the material tends to attract water, and the term “lipophobic” means that the material tends to repel lipids such as oils and fats. When a liquid having both water and lipids is applied to a porous fabric having both hydrophilic and lipophobic characteristics, the water tends to flow through the fabric, while the lipids are repelled from the fabric and prevented from flowing through to the other side of the fabric. In this way, the outer filter 130 and/or the media liner 164 operate to filter out lipid contaminants from the fluid being evacuated by the filtering pump system 100.

In general, fabric used for the outer filter 130 and/or the media liner 164 can be covalently bonded with a superior lipophobic and hydrophilic surface treatment. The resulting treated fabric will attract water to freely pass but repel hydrocarbons from reaching the filtering media 162. A superior lipophobic and hydrophilic fabric can be obtained using the techniques described in U.S. patent publication no. US20110303620, Dec. 15 2011, the teachings of which are incorporated herein by reference in their entirety. This document lists the procedures and materials to manufacture a suitable chemical nano-coating for treating the fabrics for the filtering pump system 100.

A fabric having surface enhancements that are lipophobic while also being hydrophilic allow water to freely pass through the fabric while repelling and blocking free lipids without adsorbing the lipids into the fabric's fiber matrix. This approach prevents saturation and breakthrough of the hydrocarbons. By allowing substantially only water to proceed into the effluent, the use of such treated fabrics for the outer filter 130 and/or the media liner 164 adds another failsafe to the oil-blocking, adsorbing, and/or solidifying characteristics of the filtering media 162.

In certain embodiments, the fabrics are superoleophobic and superhydrophilic fabrics such as those described in U.S. patent application publication no. 2011/0303620A1, the teachings of which are incorporated herein by reference in their entirety. In one embodiment of the present invention that filters oil from contaminated water samples, the outer filter 130 includes a chemical that is both hydrophilic and oleophobic. An example of a chemical having both hydrophilic and lipophobic characteristics is fluoroalkyl polymer. Other chemicals having these properties are described in U.S. patent publication nos. 2012/0000853, 2013/0064990, and 2014/0011013, and PCT publication no. WO 2015/177229A3, the teachings of all of which are incorporated herein by reference in their entirety. On the surface of ordinary cotton treated with the chemical, water easily spreads, while oil forms beads. When used in the outer filter 130, such treated fabric of cotton or polyester allows water to pass through it but does not allow oil to pass through it. The filter can be produced by submerging the fabric in an aqueous solution containing 10% of the chemical (or by painting or spraying the chemical onto the fabric) then drying the treated fabric in an oven (preferably at a temperature below 100 C) or in open air to form a treated fabric having the chemical bonded to the fabric. This can be verified once the coating is dried by placing droplets of water and hydrocarbons on the fabric and observing the water pass through and the hydrocarbons forming in beads on the surface.

According to certain embodiments, the filtering pump system 100 can be used for dewatering vaults and other suitable locations. This would include anything from clean water to sediment and sheen laden water to Contaminants of Emerging Concern (CEC). In these embodiments, the electric pump 170 can be a conventional bottom-suction centrifugal sump pump, such as a Grundfos KP350 Stainless Steel Pump from Grundfos Pumps Corporation of Downers Grove, Ill. Alternative embodiments may employ pumps other than electric pumps such as hydraulic pumps powered via hydraulic power and various hydraulic fluids or air pumps powered via various gases or air supplies.

By using suction through the outer filter 130, the fibers in the outer filter will not spread apart and the outer filter can have a relatively long effective lifetime. In addition, the outer filter 130 keeps gross pollutants from reaching the interior components of the filtering pump system 100, thereby providing those interior components with relatively long effective lifetimes as well.

In some embodiments, the distal end 176a of the pump discharge hose 176 can be connected to a source of clean water (or other solvent), and the electric pump 170 can be run in reverse to backwash the filtering pump system 100 to remove accumulated debris and contaminants.

Certain embodiments of the filtering pump system 100 implement high-efficiency, low-pressure (HELP) filtration technology that allows water and other liquids to free flow through the filtering media 162 with a relatively low pressure drop that provides sufficient contact time between the liquid and the filtering media to enable the filtering media to inhibit undesirable contaminants from reaching the inner cavity 154 of the pump system 100, thereby enhancing removal efficacies. The implementation of HELP filtration technology improves the efficiency of the filtering pump system 100 and lengthens the life of certain system components, such as the outer filter 130, by inhibiting sediments and gross pollutants from reaching and adversely impacting the inner fibers of the outer filter.

Embodiments of the filtering pump system of the present invention provide one or more of the following embodiments over conventional systems:
HELP Filtration Technology: Certain embodiments implement HELP filtration technology that provides enhanced removal of contaminants vs. other techniques that rely on pressurized pumping through the various media;
Modularity: Certain embodiments have the ability to be modified as the regulations and/or the environment change. The system can be reconfigured to meet specific requirements. The modularity of the system can be exploited in several ways. For example, different compositions of the outer filter 130, the media liner 164, and/or the filtering media 162 can be employed for different situations having different contaminants to be removed. In addition, these components can be selectively replaced at the end of their lifetimes to extend the overall lifetime of the system;
Portability: Certain embodiments are small enough for a single person to deploy and retrieve;
Reusability: Certain embodiments are designed for ease of maintenance and part replacement with no special tools;
Reduced Solid Waste Disposal: Certain embodiments have small integrated designs that allow for good filtration with a low amount of disposable media. In some cases, it is possible to back flush and reuse or regenerate the filtering media;
Ease of Maintenance: Certain embodiments have replaceable outer filter and filtering media as well as back-flushing capabilities; and
Targetability: Certain embodiments enable the user to configure per need, such as for different contaminants of concern, flow vs. filtering. In addition, certain embodiments allow the user to concentrate the levels of filtration to better meet both environmental and maintenance concerns.

In certain embodiments of the filtering pump system of the present invention, the filtering media 162 includes a solidifying polymer, and the outer and inner cylinders 140 and 150 hold the solidifying polymer in place with the annular gap 160 so that the solidifying polymer can shut off flow against the cylinder surfaces. The cylinders 140 and 150 can be designed such that the annular gap 160 can hold much more filtering media 162 than can be sewn into fabrics. Furthermore, by compressing the filtering media 162 within the annular gap, more-difficult pollutants like dissolved metals can be removed than when using a dusting or a bag of loose media since they tend to form channels through which water can flow without being properly filtered. In addition, the employment of HELP filtration allows water to freely move in and out through the filtering media 162 in the annular gap 160 in the normal course of an underground vault naturally filling, thereby allowing longer residency time to absorb, adsorb, and chelate pollutants. Further, the HELP filtration allows dispersion of the filtering media 162 to work as flocculants and to modify the water pH.

In the “internal pump” embodiments of FIGS. 1-8, the pump 170 is located within the system's inner cavity 154, and liquid is filtered as it flows from outside of the system 100 via HELP filtration through the various materials of the system filter 102 and into the inner cavity 154, from where the pump 170 pumps the filtered liquid away from the system 100. In alternative, “external pump” embodiments, a pump is located outside of the system filter, which is analogous to the system filter 102 of the system 100.

In one such “external pump” embodiment, an intake hose for the pump would extend from the pump into the system's inner cavity, for example, through a hose opening in the system's lid (analogous to hose opening 128 of system 100) to draw filtered liquid (that accumulates within the system's inner cavity as a result of the HELP filtration through the system filter) towards the pump and out through the pump's discharge hose. Such an embodiment could be configured, for example, with the system filter located in an underground vault and the pump located at ground level with its intake hose extending down into the inner cavity to first filter and then pump liquid from the underground vault to the ground level.

In another possible “external pump” embodiment, the pump pumps unfiltered liquid into the system's inner cavity, for example, via a discharge hose extending from the pump and into the inner cavity through a hose opening in the system's lid. In this “first pump, then filter” scenario, a “reverse-direction” HELP filtration occurs by which the unfiltered liquid pumped into the inner cavity is filtered as it passes through the various materials of the system filter. In this case, filtered liquid exits through the outer filter after the filtering of the annular filtering media. Such an embodiment could be configured, for example, with the pump (located either inside an underground vault or at ground level) configured to pump unfiltered liquid from the underground vault and into the inner cavity of the system filter, which is located at the ground level.

In alternative configurations, a pump could be configured to pump unfiltered liquid into the inner cavities of two or more different system filters that filter the unfiltered liquid in parallel using “reverse-direction” HELP filtration to provide increased throughput. Note that the “internal pump” system 100 of FIGS. 1-8 could also be configured with its filtered discharge being applied to the inner cavities of one or more other system filters (without pumps) to provide further, “reverse-direction” HELP filtration of the already-filtered liquid discharged from the “internal pump” system 100.

In other alternative configurations, a pump could be configured to pump liquid into a set of two or more filter stages connected in series end-to-end, where the final filter stage is the system filter of the present invention configured to receive liquid, for example, through the hose opening in its lid, from the previous filter stage. In this way, each successive intermediate filter between the pump and the system filter could provide some additional degree of filtering, and the final, system filter would provide a final amount of filtering before the filtered liquid exits the system filter through its outer filter. Note that each intermediate filter could be a modified version of the system filter of the present invention with an outer cylinder having no perforations, no outer filter, and an opening in the filter's base, such that liquid could enter the intermediate filter through an opening in the filter's lid, be filtered by the annular filtering media, and exit the intermediate filter through an opening in the filter's base.

Depending on the particular implementation, these “external pump” embodiments might or might not have mechanisms for automatically controlling the pump based on detected liquid level. If an “external pump” embodiment does have such a mechanism, then the mechanism will need to be able to detect the liquid level within the system's inner cavity and be able to communicate with the externally located pump.

In certain system filter embodiments, the invention is a system filter for a filtering pump system, the system filter comprising a base; a hollow, perforated, outer structure having an inner cavity and mounted onto the base; a hollow, perforated, inner structure having an inner cavity and mounted onto the base within the inner cavity of the outer structure to define an annular gap between the outer and inner structures, wherein the annular gap is configured to receive filtering media configured to filter liquid passing through the annular gap; and an outer filter surrounding the outer structure and configured to filter liquid passing through the outer filter.

When the filtering pump system comprises the system filter and a pump configured to pump liquid away from the inner cavity of the inner structure, the liquid flows from outside of the system filter through the outer filter, then through perforations in the perforated outer structure, then through the filtering media, and then through perforations in the perforated inner structure into the inner cavity of the inner structure. When the filtering pump system comprises the system filter and a pump configured to pump liquid into the inner cavity of the inner structure, the liquid flows from the inner cavity of the inner structure through the perforations in the inner structure, then through the filtering media, then through the perforations in the outer structure, and then through the outer filter away from the system filter.

In the foregoing system filter embodiments, the outer filter may be configured to inhibit gross pollutants from passing through the outer filter.

In each of the foregoing system filter embodiments, the outer filter comprises a solidifier configured to combine with lipid molecules in the liquid and form a barrier that provides secondary containment.

In each of the foregoing system filter embodiments, the annular gap may be further configured to receive a media liner configured to retain the filtering media within the annular gap, while allowing liquid to pass through the media liner and the filtering media.

In each of the foregoing system filter embodiments, the media liner may comprise (i) an outer portion located between the outer structure and the filtering media and configured to allow liquid to pass between the outer structure and the filtering media and (ii) an inner portion located between the filtering media and the inner structure and configured to allow liquid to pass between the filtering media and the inner structure.

In each of the foregoing system filter embodiments, the filtering media may comprise a solidifier configured to combine with lipid molecules in the liquid and form a barrier that provides secondary containment.

In each of the foregoing system filter embodiments, the outer structure is a hollow may be perforated cylinder having a first diameter, and the inner structure may be a hollow, perforated cylinder having a second diameter smaller than the first diameter.

In each of the foregoing system filter embodiments, the system filter may further comprise a resilient media gasket located within the annular gap and configured to apply compression forces to the filtering media.

In each of the foregoing system filter embodiments, the outer filter may comprise a hydrophilic, lipophobic material that tends to attract water and repel lipids, wherein the hydrophilic, lipophobic material inhibits lipids in the liquid from passing through the outer filter without having the lipids adhere to the outer filter.

In certain filtering pump system embodiments, the invention is a filtering pump system comprising the system filter and a pump.

In the foregoing filtering pump system embodiments, the pump may be configured to pump liquid away from or into the inner cavity of the inner structure. If the pump is configured to pump liquid away from the inner cavity, then the pump may be located either within the inner cavity of the inner structure or external to the system filter. If the pump is configured to pump liquid into the inner cavity, then the pump is located external to the system filter.

In each of the foregoing filtering pump system embodiments, the outer filter may be configured to inhibit gross pollutants from passing through the outer filter; at least one of the outer filter and the filtering media may comprise a solidifier configured to combine with lipid molecules in the liquid and form a barrier that provides secondary containment; the outer structure may be a hollow, perforated cylinder having a first diameter; the inner structure may be a hollow, perforated cylinder having a second diameter smaller than the first diameter; the system filter may further comprise a resilient media gasket located within the annular gap and configured to apply compression forces to the filtering media; and the outer filter may comprise a hydrophilic, lipophobic material that tends to attract water and repel lipids, wherein the hydrophilic, lipophobic material inhibits lipids in the liquid from passing through the outer filter without having the lipids adhere to the outer filter.

In each of the foregoing filtering pump system requirements, the annular gap may be further configured to receive a media liner configured to retain the filtering media within the annular gap, while allowing liquid to pass through the media liner and the filtering media. The media liner may comprise an outer portion located between the outer structure and the filtering media and configured to allow liquid to pass between the outer structure and the filtering media and an inner portion located between the filtering media and the inner structure and configured to allow liquid to pass between the filtering media and the inner structure.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A system filter for a filtering pump system, the system filter comprising:
a base;
a hollow, perforated, outer structure having an inner cavity and mounted onto the base;
a hollow, perforated, inner structure having an inner cavity and mounted onto the base within the inner cavity of the outer structure to define an annular gap between the outer and inner structures, wherein the annular gap is configured to receive filtering media configured to filter liquid passing through the annular gap; and
an outer filter surrounding the outer structure and configured to filter liquid passing through the outer filter, wherein:
when the filtering pump system comprises the system filter and a pump configured to pump liquid away from the inner cavity of the inner structure, the liquid flows from outside of the system filter through the outer filter, then through perforations in the perforated outer structure, then through the filtering media, and then through perforations in the perforated inner structure into the inner cavity of the inner structure; and
when the filtering pump system comprises the system filter and a pump configured to pump liquid into the inner cavity of the inner structure, the liquid flows from the inner cavity of the inner structure through the perforations in the inner structure, then through the filtering media, then through the perforations in the outer structure, and then through the outer filter away from the system filter.

2. The system filter of claim 1, wherein the outer filter is configured to inhibit gross pollutants from passing through the outer filter.

3. The system filter of claim 1, wherein the outer filter comprises a solidifier configured to combine with lipid molecules in the liquid and form a barrier that provides secondary containment.

4. The system filter of claim 1, wherein the annular gap is further configured to receive a media liner configured to retain the filtering media within the annular gap, while allowing liquid to pass through the media liner and the filtering media.

5. The system filter of claim 4, wherein the media liner comprises:
an outer portion located between the outer structure and the filtering media and configured to allow liquid to pass between the outer structure and the filtering media; and
an inner portion located between the filtering media and the inner structure and configured to allow liquid to pass between the filtering media and the inner structure.

6. The system filter of claim 1, wherein the filtering media comprises a solidifier configured to combine with lipid molecules in the liquid and form a barrier that provides secondary containment.

7. The system filter of claim 1, wherein:
the outer structure is a hollow, perforated cylinder having a first diameter; and
the inner structure is a hollow, perforated cylinder having a second diameter smaller than the first diameter.

8. The system filter of claim 1, further comprising a resilient media gasket located within the annular gap and configured to apply compression forces to the filtering media.

9. The system filter of claim 1, wherein the outer filter comprises a hydrophilic, lipophobic material that tends to attract water and repel lipids, wherein the hydrophilic, lipophobic material inhibits lipids in the liquid from passing through the outer filter without having the lipids adhere to the outer filter.

10. The system filter of claim 1, wherein:
the outer filter is configured to inhibit gross pollutants from passing through the outer filter;
at least one of the outer filter and the filtering media comprises a solidifier configured to combine with lipid molecules in the liquid and form a barrier that provides secondary containment;
the outer structure is a hollow, perforated cylinder having a first diameter;
the inner structure is a hollow, perforated cylinder having a second diameter smaller than the first diameter;
the system filter further comprises a resilient media gasket located within the annular gap and configured to apply compression forces to the filtering media; and
the outer filter comprises a hydrophilic, lipophobic material that tends to attract water and repel lipids, wherein the hydrophilic, lipophobic material inhibits lipids in the liquid from passing through the outer filter without having the lipids adhere to the outer filter.

11. The system filter of claim 10, wherein:
the annular gap is further configured to receive a media liner configured to retain the filtering media within the annular gap, while allowing liquid to pass through the media liner and the filtering media; and
the media liner comprises:
an outer portion located between the outer structure and the filtering media and configured to allow liquid to pass between the outer structure and the filtering media; and
an inner portion located between the filtering media and the inner structure and configured to allow liquid to pass between the filtering media and the inner structure.

12. The filtering pump system of claim 1.

13. The filtering pump system of claim 12, wherein the pump is configured to pump liquid away from the inner cavity of the inner structure.

14. The filtering pump system of claim 13, wherein the pump is located within the inner cavity of the inner structure.

15. The filtering pump system of claim 13, wherein the pump is located external to the system filter.

16. The filtering pump system of claim 12, wherein the pump is located external to the system filter and configured to pump liquid into the inner cavity of the inner structure.

17. The filtering pump system of claim 12, wherein:
the outer filter is configured to inhibit gross pollutants from passing through the outer filter;
at least one of the outer filter and the filtering media comprises a solidifier configured to combine with lipid molecules in the liquid and form a barrier that provides secondary containment;
the outer structure is a hollow, perforated cylinder having a first diameter;
the inner structure is a hollow, perforated cylinder having a second diameter smaller than the first diameter;
the system filter further comprises a resilient media gasket located within the annular gap and configured to apply compression forces to the filtering media; and
the outer filter comprises a hydrophilic, lipophobic material that tends to attract water and repel lipids, wherein the hydrophilic, lipophobic material inhibits lipids in the liquid from passing through the outer filter without having the lipids adhere to the outer filter.

18. The filtering pump system of claim 17, wherein:
the annular gap is further configured to receive a media liner configured to retain the filtering media within the annular gap, while allowing liquid to pass through the media liner and the filtering media; and
the media liner comprises:
an outer portion located between the outer structure and the filtering media and configured to allow liquid to pass between the outer structure and the filtering media; and
an inner portion located between the filtering media and the inner structure and configured to allow liquid to pass between the filtering media and the inner structure.
